(19) United States
(12) Patent Application Publication
(10) Pub. No.: US 2014/0368518 A1
(43) Pub. Date: Dec. 18, 2014

(54) METHOD AND A SYSTEM FOR CONFIGURATION AND DISTRIBUTION OF A COMPUTER READABLE FILE

(71) Applicants: Michael SMITH, Smithtown, NY (US); Andrew JACOBS, Centerport, NY (US); Danielle SMITH, Smithtown, NY (US)

(72) Inventors: Michael SMITH, Smithtown, NY (US); Andrew JACOBS, Centerport, NY (US); Danielle SMITH, Smithtown, NY (US)

(21) Appl. No.: 14/304,115

(22) Filed: Jun. 13, 2014

Related U.S. Application Data
(60) Provisional application No. 61/834,554, filed on Jun. 13, 2013.

(51) Int. Cl. G06T 1/60

(52) U.S. Cl. CPC G06T 1/60
USPC 345/530

(57) ABSTRACT

Disclosed is a method and a system for configuration and distribution of a computer readable file to display a memorial message, the memorial message including elements selected by a sponsor user for display to members of a group, at least one of the elements being an image of a burning candle.

### CROSS-REFERENCE TO RELATED APPLICATIONS

The present non-provisional patent application claims the benefit of priority from U.S. Provisional Patent Application No. 61/834,554, filed Jun. 13, 2013, entitled “METHOD AND A SYSTEM FOR CONFIGURATION AND DISTRIBUTION OF A COMPUTER READABLE FILE”, the entire contents of which is incorporated herein by reference.

### FIELD OF INVENTION

The present invention relates to a method and a system for the configuration of a computer readable file for the purpose of displaying an image and distribution of the configured computer readable file.

### DEFINITIONS

Computer readable file (CRF) as used herein means an electronic file or a collection of electronic files including data and/or computer executable code that can be processed by a computer.

Browser readable file (BRF) as used herein means a CRF or a collection of CRFs containing computer executable code that can be executed by a browser software residing on a computer for the purposes of carrying out instructions including operating an associated computer display to display content to a user, and sending/receiving data or instruction from another computer.

Web page or webpage as used herein refers to an electronic document/file residing on a computer (sometimes referred to as a server) in a network of computers that may be accessed by a web browser for the purpose of displaying information including text, graphics and the like to a user via an electronic display.

A web site or website refers to a set or a collection of interrelated web pages residing on a computer or a number of computers in a network of computers and accessible by a user via an electronic address typically referred as a uniform resource locator (URL) or web address.

A browser or web browser refers to a software application for accessing, retrieving, presenting (displaying), and traversing information residing on computers in a network of computers including websites, web pages, weblogs (blogs) or the like.

Click and its grammatical variations refers to operating a pointing device associated with a computer (e.g. a mouse) to select an item on the electronic display of the computer, which leads to the activation of a command or function that is executed by the computer associated with the display.

### BACKGROUND AND SUMMARY OF THE DISCLOSURE

Lighting a candle in remembrance, for example, of a person who has passed away is a well known tradition.

A system according to the present invention allows for the configuration of a CRF, which when executed by a computer, allows for the display of an image on a display device associated with the executing computer. The image so displayed may include the image of a burning candle at a stage of consumption temporally located between an initial stage of consumption and a final stage of consumption of the candle.

A system according to the present invention is configured, for a predetermined period of time, to provide a CRF as described above, thereby emulating the experience of observing the consumption of a candle over a period of time.

A system according to the present invention can offer a person, a religious organization, a charitable organization, or any other organization a unique way to engage and interact with others.

A system according to the present invention can stimulate, through inspiration, donations by others through social, online interactivity.

In one embodiment, a CRF as described above can be generated and provided at any time within a predetermined period of time, for example, for a twenty four hour period of time. Each time a CRF is generated, it will include an image of a burning candle coinciding with the time the CRF is generated. Thus, for example, after three hours has passed, the image of the candle may represent a burning candle that is about 15% consumed. Thus, the system emulates for the user the experience of observing a candle that is consumed over a period of time. The period of time may be extended upon a request made to the system.

According to an embodiment of the present invention, no fee is charged for the configuration of a CRF as described above. Rather, a charitable donation may be made via a system according to the present invention.

In another embodiment, an organization, such as a non-profit organization may set up a landing page that is hosted by a system according to the present invention, and members of the organization may make donations to the organization by configuring a CRF as described above.

A system according to the present invention can distribute a CRF as described above through an e-mail service, or through a third party service such as a social networking site, thereby increasing the likelihood of raising funds through donations generated by the “viral” distribution of the CRF through the network of the systems users.

Thus, with a system according to the present invention:
individuals and/or families can easily share the sentiments associated with a burning candle electronically;
an individual can share sentiment associated with a burning candle to communicate a tribute to anyone in the world, creating a community around a loved one's life in just minutes;
an individual can creatively build a CRF to display a customized image from start to finish;
an individual can chose to donate to a charity or a religious institution of choice that may be a registered organization.

An institution or organization:
can be included in a system according to the present invention;
can build and strengthen relationships with its members by using a system according to the present invention;
can establish another way of communicating with members and non-members alike;
can raise funds through a system according to the present invention.

Other features and advantages of the present invention will become apparent from the following description of the invention which refers to the accompanying drawings.

### BRIEF DESCRIPTION OF THE FIGURES

FIG. 1 illustrates a system according to the present invention.

FIG. 2 illustrates an image displayable by a computer and generated based on a CRF configured according to the present invention.

FIG. 3 illustrates an example of a time line for provision of temporal images of a burning candle displayable by a computer display.

FIG. 4 shows a flow chart indicating some of the steps in collecting information for construction of a CRF according to the present invention.

FIG. 5 shows a first form, in a series of forms, for collection of information for the construction of a CRF according to the present invention.

FIG. 6 shows a second form, in a series of forms, for collection of information for the construction of a CRF according to the present invention.

FIG. 7 shows a third form, in a series of forms, for collection of information for the construction of a CRF according to the present invention.

FIG. 8 shows a fourth form, in a series of forms, for collection of information for the construction of a CRF according to the present invention.

FIG. 9 shows a fifth form, in a series of forms, for collection of information for the construction of a CRF according to the present invention.

FIG. 10 illustrates a process flow for handling of an order by a computing processing center.

FIG. 11 illustrates examples of graphical hyperlinks (banner).

FIG. 12 illustrates a report that can be produced in a system according to the present invention.

FIG. 13 illustrates a fillable form for an institutional user of a system according to the present invention.

FIG. 14 illustrates another fillable form for an institutional user of a system according to the present invention.

FIG. 15 illustrate a process flow for handling of information received from an organization to create a landing page, to send out e-mails on behalf of the organization, and to post the landing page on a third party service on behalf of the organization.

FIG. 16 shows a process flow for automatic request generation to request participation by an organization.

FIG. 17 illustrates the components of a web site (e.g. the web pages) residing in a system according to the present invention.

FIGS. 18A and 18B illustrate forms for receiving information from a user to construct a message according to another embodiment of the present invention.

FIG. 19 illustrates a displayed message based on the information obtained through forms shown in FIGS. 18A and 18B.

### DETAILED DESCRIPTION

Disclosed below is a system that allows a user to configure a CRF to enable a computer to display an image via a display associated with the computer.

A computer as used herein refers to any type of computing device such as a PC, a tablet computer, a smart phone or the like device capable of processing a CRF and operating a display device to display an image to a user, which includes a microprocessor and a non-transitory memory that is readable by the microprocessor.

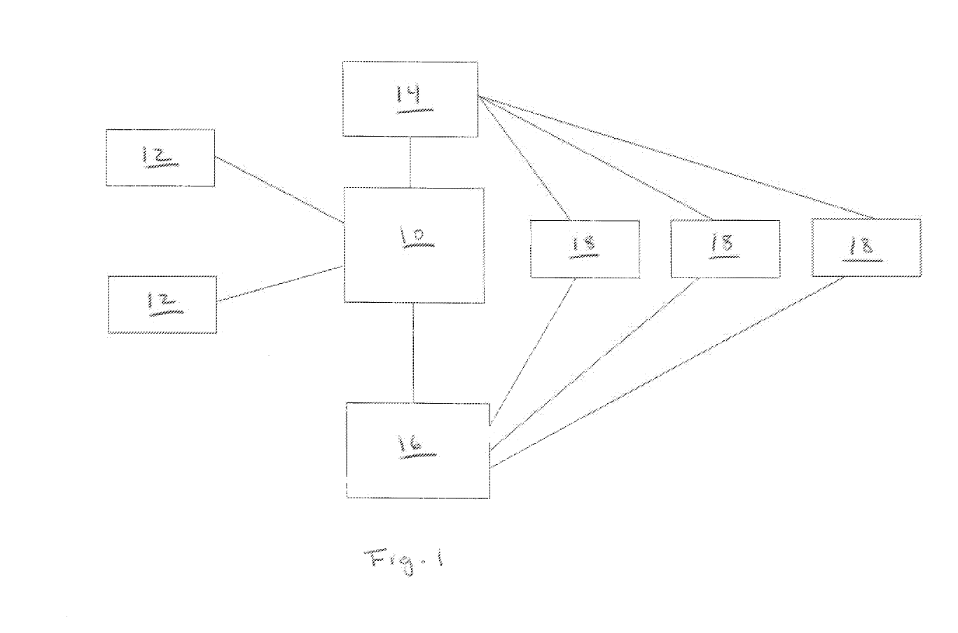

FIG. 1 illustrates the components of a system for the configuration and the distribution of a CRF according to the present invention.

The system includes a computing processing center (CPC) 10, which may be one or a collection of several computers configured for the implementation of a method as described herein. Preferably, CPC 10 is configured as a website programmed to render all necessary functionalities described herein and including all necessary databases for the storage of information and data in non-transitory memory location or locations necessary to realize the functionalities described hereafter.

CPC 10 is operatively connectable to a plurality of sponsor computers 12 for the purpose of communicating data, computer executable instructions, and CRFs. CPC 10 and sponsor computers 12 may be connected via a publicly accessible network of computers such as the Internet.

CPC 10 may be connectable to an e-mail server 14 for the purpose of sending out an e-mail to an e-mail address on an e-mail list.

CPC 10 may also be connectable to a third party system (TPS), via, for example, the Internet, for the purpose of directing a CRF to TPS 16. A TPS 16 may be a social networking website such as Facebook or may be some other social networking service.

A plurality of recipient computers 18 can receive e-mails from e-mail server 14. The e-mails may contain a CRF that can be processed by the receiving computer to display an image, or may contain a browser readable address (typically referred to as a link) that allows the recipient computer to access the CRF. The address so provided, for example, can direct a browser resident on the receiving computer 18 to a web page, for example, that includes a CRF which when processed by the receiving computer will result in the display of an image by a display associated with the processing computer. Preferably, in this embodiment, the CRF may be an HTML or HTML5 file, or any other suitable version. A CRF sent as an attachment to an e-mail may be in any suitable format.

Alternatively or in addition, a recipient computer 18 may access a CRF provided by CPC 10 by directing the browser resident thereon to a web page provided on TPS 16.

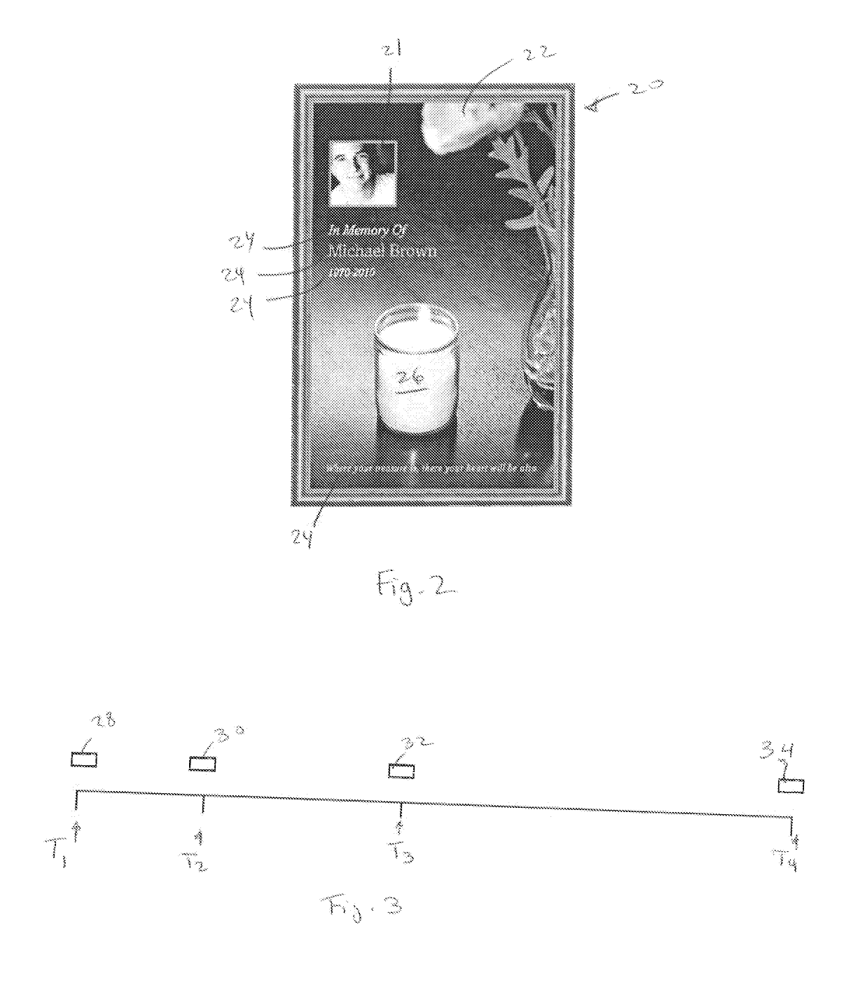

FIG. 2 illustrates an image 20 displayed by the display device of a computer that has processed a CRF configured according to the present invention.

Image 20 may include image elements such as a background image 22 (e.g. image of a flower), text 24, a personal image 21, and a temporal (i.e. variable over time) image 26.

According to the present invention, temporal image 26 may be the image of a burning candle at a given time after the candle is lit and represents a burning candle at a given state of consumption. Thus, for example, image 20 may include an image of a candle 26 after it has burned for four hours.

According to an aspect of the present invention, every time an image 20 is displayed by a display associated with a computer, the image so displayed displays the image of the candle in a temporal state relative to the image of the candle at an initial state.

Preferably, the initial state represents the moment the candle is lit, and each temporal state occurs thereafter. However, that is not required. For practical purposes the initial state is the first image of the candle in a lit state at its lowest state of consumption, and each temporal state occurs thereafter until the final state, which is the image of the candle at its highest state of consumption. Thus, at any given temporal state, the image displayed by a display device associated with a computer is the image of the candle at a given consumption state.

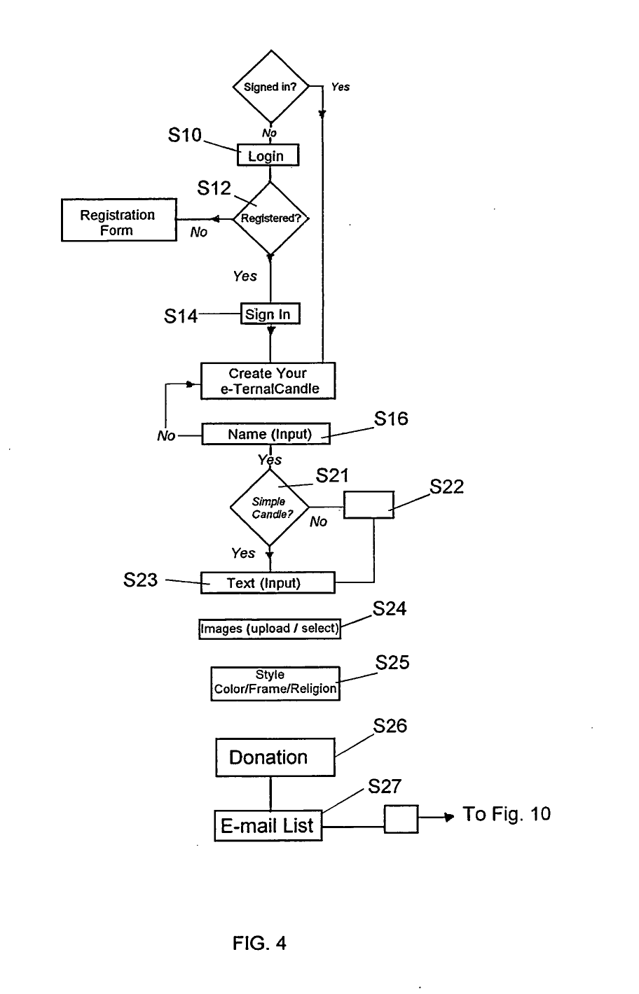

FIG. 3 illustrates a typical time line. Time T₁ is the initial state. At this time, the CRF provided by CPC 10, when processed by a computer, would result in the display of an image 28 of a burning candle at its initial state of consumption (e.g. less than 2% consumed). At time T₂, another CRF provided by CPC 10, when processed by a computer, would result in the display of an image 30 of the lit candle at another temporal state (e.g. 15% consumed). Similarly, at T₃ yet another CRF provided by CPC 10, when processed by a computer, would result in the display of an image 32 at yet another temporal state (e.g. 40% consumed). Thus, by accessing CPC 10 with a computer at different times one can experience watching a burning candle over time. Preferrably, each image 28,30,32, or other image representing a candle in a state of consumption is a digital image (in an suitable format) of an actual candle burning.

According to an aspect of the present invention, CPC 10 provides a CRF for a predetermined time, for example, for twenty four hours. Thus, at time T₄ (which would be twenty four hours after T₁) a CRF provided by CPC 10, when processed by a computer, would display an image 34 of the candle at its final state (e.g. 95% consumption). Predetermined time as used herein means the total time between T₁-T₄.

According to another aspect of the present invention, the initial time T₁ would coincide with the initial time CPC 10 is authorized to provide a CRF to other computers to display the temporal images of the burning candle. CPC 10 would automatically terminate accessibility to a CRF after passage of a predetermined time (e.g. twenty four hours), which would coincide with time T₄.

According to yet another aspect of the present invention, when a computer gains access to CPC 10 at a time falling inside the predetermined time (total time between T₁ to T₄), a CRF is provided that when processed by the receiving computer results in the display of a burning candle by a display associated with the receiving computer at a temporal/consumption state coinciding with the time the CRF is provided. A CRF containing information for the display of the burning candle at higher consumption states may be provided thereafter, but not lower consumption states.

For example, when CPC 10 is instructed to begin providing a CRF at 1:00 PM, and a request for a CRF is made by a computer at 3:00 PM, the image of a burning candle displayed by the requesting computer will be at a higher consumption state than an image of the burning candle that could have been displayed if the request for the CRF had been made at 2:00 PM or 1:15 PM. However, as long as the requesting computer remains in communication with CPC 10 (i.e. as long as the session is not terminated), CPC 10 may continually provide updated CRFs to the requesting computer to display the burning candle at higher states of consumption, or update the CRF received by the requesting computer so that image 26 changes to show the burning candle at higher states of consumption. The process may continue until communication between CPC 10 and the receiving computer is terminated.

Optionally, the predetermined time may be selectively extended. Thus, for example, a user of the system could submit a request to extend the predetermined time for another twenty four hours, in which case CPC 10 will reset the time and continue to provide a CRF to a requesting computer. Thus, CPC 10 may be configured to receive a request from a user other than the sponsor (i.e. the user who provided the information for the construction of a CRF to display an image 20) to continue to make the CRF available for another predetermined time. The request so made may be, preferably, tied to pledge of or an actual donation to an organization registered with CPC 10. It should be noted that the predetermined time may be selected in relation to the amount of donation. Thus, an additional donation can be collected in exchange for “keeping the candle lit” for another extended period of time. Moreover, the amount of donation may be related to the amount of time. For example, a $10 donation can add another twenty four hours of accessibility, and $20 another forty eight hours of accessibility to a CRF for displaying an image 20. Thus, an organization, such as the American Cancer Society, that would like to commemorate its 100th year anniversary, could have users provide information to create a CRF for displaying an image 20, and each user could ask from his/her network for a $10 donation to keep “the candle burning” (i.e. keep the CRF accessible) for a twenty four hour period for each $10 donation.

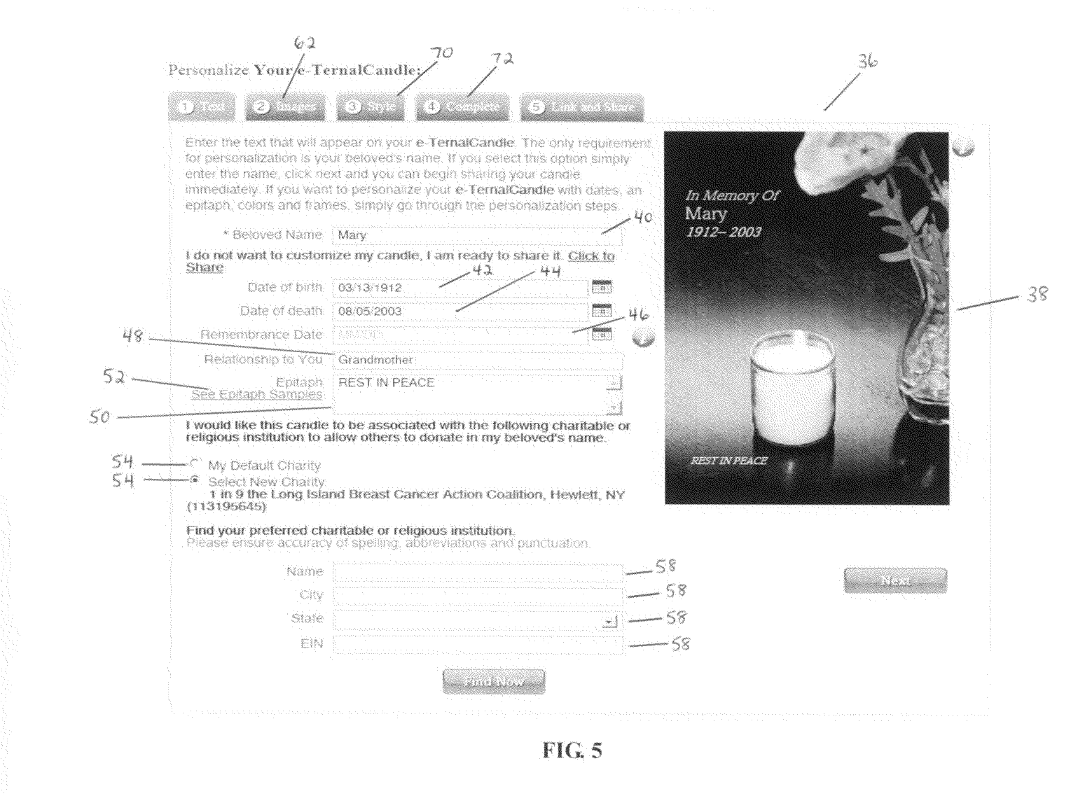

Referring now to FIG. 4, a sponsor can access CPC 10 via a sponsor computer 12 in order to supply CPC 10 with data and instructions to configure a CRF that can be processed by a computer to display an image 20.

In one embodiment, temporal image 26 is an image from a group of images, the group including an initial image of a candle burning at its lowest state of consumption and a plurality of temporal images of the same burning candle each at a different, higher state of consumption. Each image in this group of images is an image of a burning candle and the images are displayed to the user in a sequence from a lowest state of consumption to the highest state of consumption over the predetermined period of time. In this embodiment, a digital computer readable file is stored in a memory location in CPC 10 that contains the data based on which a computer may direct the display of one of the images in the group of images of the burning candle. For example, twenty four digital computer readable files can be stored to represent, in sequence, the images of a burning candle over time. When the predetermined time is to be twenty four hours, each digital computer readable file is used to display an image of the candle at a given state of consumption for a given hour in the predetermined period of time. To be more specific, for example, the first image (the candle burning in its first and lowest state of consumption) is displayed based on the data in the first digital computer readable file, the second image (the candle burning in its second lowest state of consumption higher than the first) is displayed based on the data in the second digital computer readable file for the second hour in the twenty four period of time and so on until all twenty four images are displayed sequentially for the predetermined period of time. The predetermined period of time may be set as a default by the system or may be received from the user. Based on the predetermined period of time, the system CPC 10 calculates the length of time for the display of each image in the group of images. It should be noted that while in the example provided here each image is displayed for an equal amount of time (one hour), it should not be understood that the present invention is limited in that way. Rather, CPC 10 may be programmed to assign a period of time for the display of each image in the group of images according to another formula. However, each image in the group of image will be displayed for a given period of time shorter than the predetermined time and there will be more than one image in the sequence of images at least one of which will be a candle burning at an initial (lowest) state of consumption followed, in sequence, by images of the same candle at different, higher states of consumption.

Each digital computer readable file may include data/information that, when processed by a computer, leads to the display of a burning candle, in which the flame flickers. In an embodiment of the present invention, the flickering portion of the image may remain the same from image to image while the body of the candle is displayed shorter relative to the previous (lower state of consumption), thereby displaying a burning candle that is being consumed over a period of time.

According to a preferred embodiment, a sponsor directs the browser residing on a sponsor computer 12 to a web site hosted/residing at CPC 10. CPC 10 may first provide to sponsor computer 12 a BRF to display a homepage on a display device associated with the sponsor computer 12. The homepage may include a selectable button (e.g. a Log In button), which when clicked by the sponsor, causes an instruction to be sent to CPC 10 to provide a BRF to the sponsor computer 12. The BRF so sent will cause the browser of the sponsor computer 12 to display a web page that requests information from the sponsor to authorize the sponsor to proceed further. Such a webpage may be called a Log In page and may include a fillable form that can be filled by the sponsor using the sponsor computer 12.

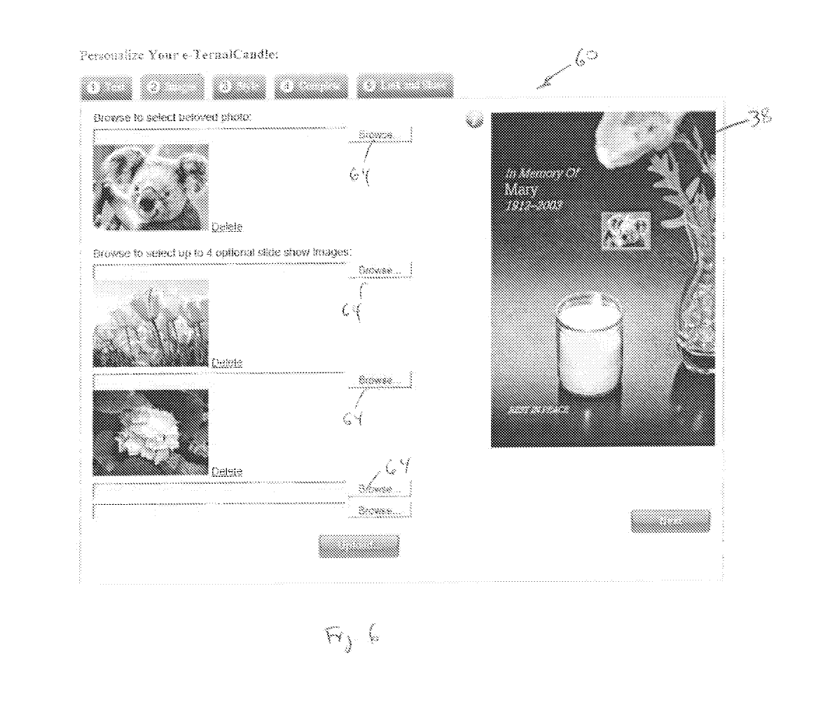

At S10, information entered by the sponsor into the login page form is passed to CPC 10. CPC 10 then determines whether the sponsor is a registered user (S12). If not, CPC 10 sends a BRF to sponsor computer 12 to display a computer fillable registration form for the purpose of registering the sponsor as a user with CPC 10. If the sponsor is determined to be a registered user, then sponsor computer 12 is authorized (S14) and a BRF is sent to sponsor computer 12 to display a first fillable form 36 by a display associated with the sponsor computer 12 an example of which is shown by FIG. 5.

Form 36 may be configured to display a preview 38 of an image 20 for the sponsor to view. Form 36 may further include a field 40 for the entry of the name of a person, a field 42 for the date of birth of that person, a field 44 for the date of death of that person, a field 46 for a remembrance date, a field 48 for information indicating the relationship of the sponsor to the person named in field 40, and a field 50 for an epitaph or the like. The information provided in fields 40-44, 48, and 50 are then displayed in preview image 38 for the sponsor to review.

The remembrance date will be stored in CPC 10. The purpose of the remembrance date is to re-initiate a predetermined time at a certain date in the future, for example, a year after the first predetermined time. At the remembrance date, CPC 10 may re-initiate a predetermined, or may send a reminder via, for example, an e-mail service to the sponsor to reinitiate the predetermined time.

Preferably, the computer processing for the display of preview image 38 is carried out by sponsor computer 12 (i.e. it is client-side processed).

Form 36 may further include a hyperlink 52, which when selected by the sponsor, may result in the display of sample epitaphs in a list or the like from which the sponsor may select an epitaph.

Form 36 may further allow the sponsor to select a charity organization or the like. Thus, a plurality of radio buttons 54 may be provided so that the user may select either a default charity (previously stored in and associated with the registered sponsor by CPC 10), or to select a charity from a list.

Form 36 may be provided with one or more fields 58 to collect information from the sponsor in order to search for a charity organization when the sponsor selects the radio button 54 associated with the selection of a new charity. The information entered into fields 58 is then passed to CPC 10. CPC 10 includes a charity database in which information relating to a number of charity organizations is stored. If the charity selected by the sponsor is found in the charity database CPC 10 will associate the selected charity organization with the sponsor's order.

FIG. 5 illustrates a form 36 for obtaining textual information that is used to construct a CRF for the display of image 20.

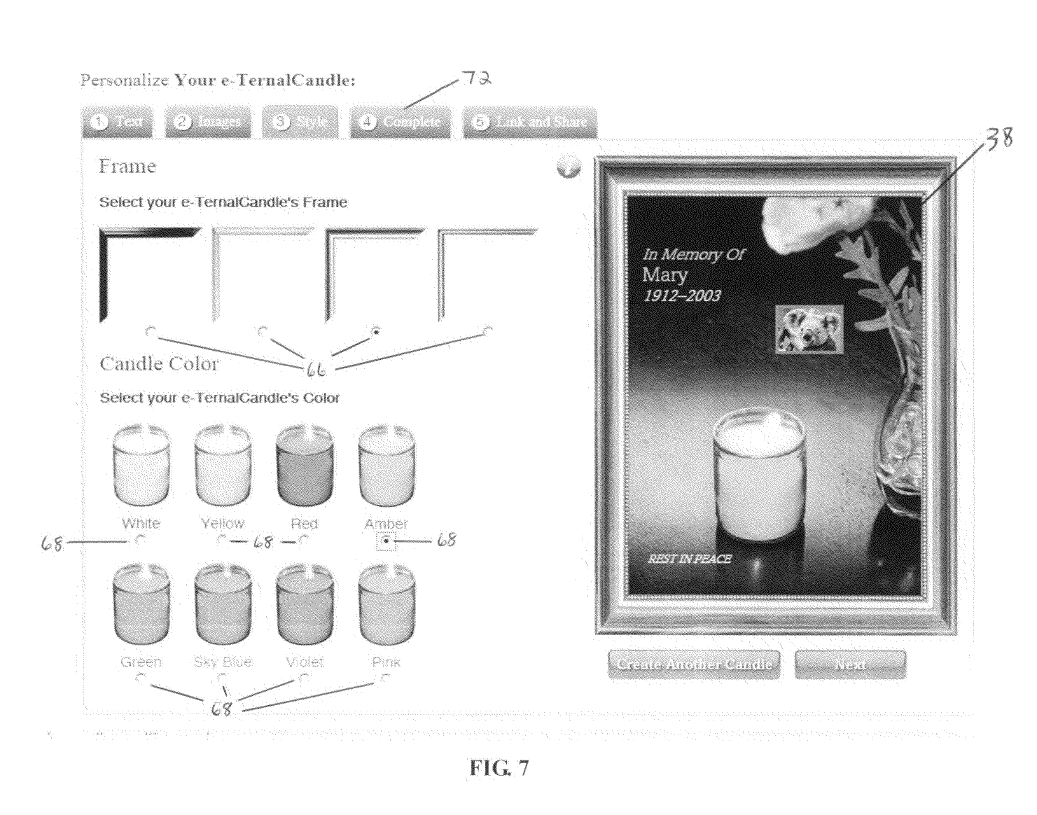

Referring to FIG. 6, CPC 10 may further provide a BRF to display a form 60 to obtain a computer readable image file for display of an image 21 inside image 20. The image file may be obtained from sponsor computer 12 in any conventional manner and image 21 is displayed in preview image 38 upon selection. Note that the BRF for displaying form 60 may be provided when sponsor clicks tab 62 (see FIG. 5). It should be noted that the sponsor may select and upload a computer readable image file to display a static image 21 or upload a computer readable file containing a plurality of related image files to display a slideshow or the like.

The browse buttons 64 when clicked by the sponsor allows the sponsor to search for a computer readable image file on the sponsor computer 12, or some other location.

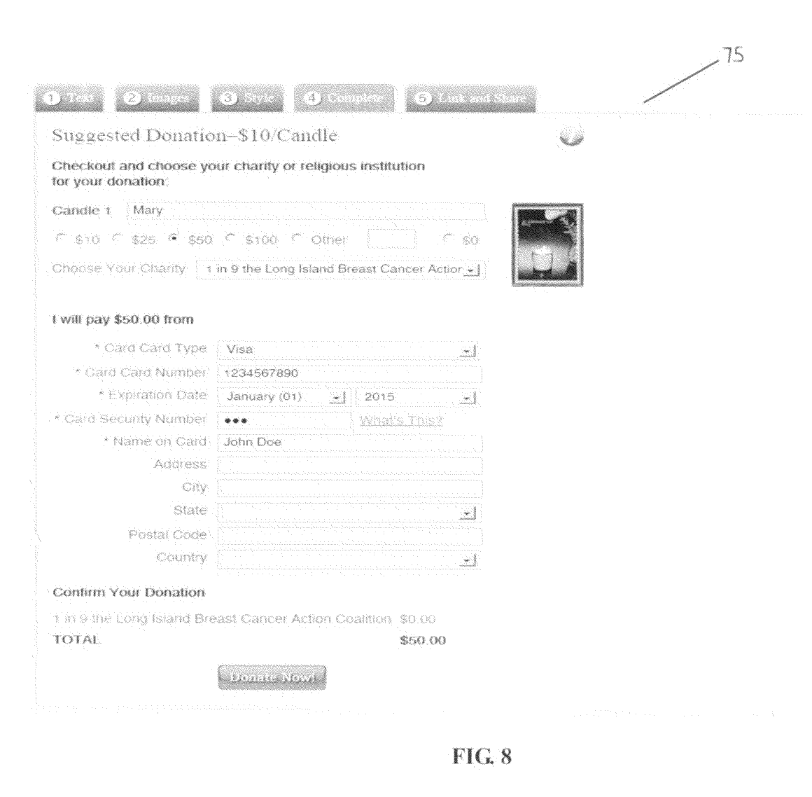

Image 20 may be further customized by the sponsor. Referring to FIG. 7, for example, the sponsor may select a frame style by clicking one of the radio buttons 66 associated with the image of a frame. Moreover, the sponsor may be able to select the color of the candle which will appear in image 20 by selecting one of the radio buttons 68 associated with the image of a burning candle. The user's selections will alter the preview image. The sponsor may receive a BRF for displaying the form shown in FIG. 7 from CPC 10 when the sponsor clicks tab 70.

It should be noted that CPC 10 will have stored, in a non-transitory memory location, computer readable image files for the display of a selected candle in a plurality of temporal/consumption states in order to provide a CRF as described herein to a requesting computer.

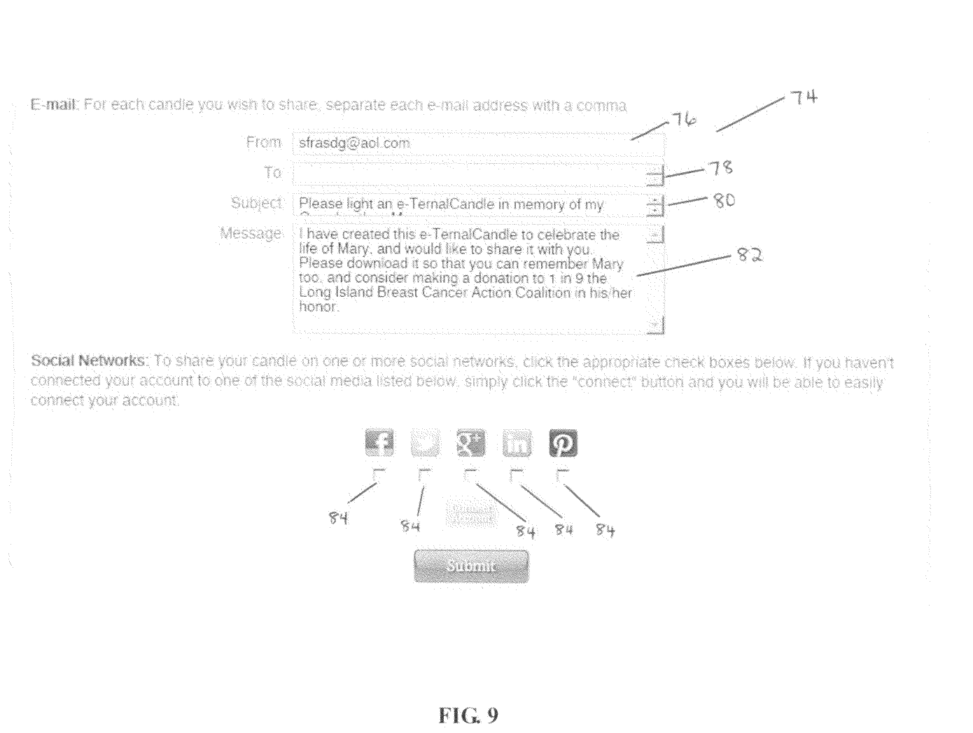

The sponsor can click on button 72, which will result in the CPC 10 providing a BRF to display form 75 (FIG. 8) to allow the sponsor to make a charitable contribution to the sponsor's selected charity. CPC 10 receives and processes the payment information entered into form 75.

CPC 10 will configure a CRF for displaying an image 20 according to the sponsor's input selections received by CPC 10 including the textual information (FIG. 5), computer readable image file for image 21 (FIG. 6), and further customization selections (FIG. 7).

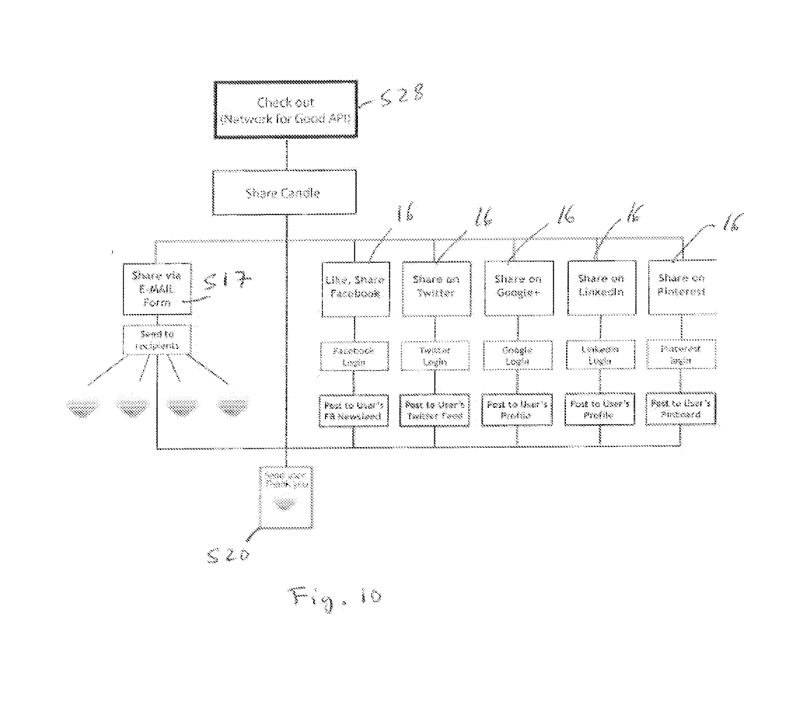

CPC 10 also provides to the sponsor computer 12 a BRF to display a fillable form 74 to the sponsor as, for example, illustrated in FIG. 9. Form 74 includes fields for the entry of information for the construction of an e-mail which will be sent by CPC 10 on behalf of the sponsor. Thus, there will be a field 76 for the sponsor's e-mail, a field 78 for the e-mail addresses of the recipients of the sponsor's e-mail, a field 80 for the subject, and a field 82 for the sponsor's message.

Form 74 may also allow the sponsor to select at least one TPS 16. Thus, a plurality of selection boxes 84 may be provided in form 74, each associated with a different TPS 16 that, when accessed by a browser on another computer, will supply a CRF for the display of an image 20 provided by CPC 10 according to the sponsor's selections.

It should be noted that all BRFs for the forms necessary for obtaining information from the sponsor to configure a CRF (i.e. order forms) may be sent together by the CPC 10 after the sponsor computer 12 is granted access to CPC 10 (i.e. after Log In), and the information so entered may be retained in sponsor computer 12 until it is submitted to CPC 10. That is, there is no need to submit each filled out form separately and wait for another form.

Referring back to FIG. 4, CPC 10, upon receipt of information from the sponsor through, for example, the process described above, proceeds to associate and store in CPC 10 the information received for the construction of a CRF for the display of an image 20 according to the sponsor's selections. Thus, at S16, CPC 10 determines whether a name was provided in field 40 (FIG. 5). If not, an error message may be sent to the sponsor computer 12. If so, CPC 10 determines the sponsor's candle selection S21, if any, (see FIG. 7). If no selection is made, a default selection of a candle will be made S22. Thereafter, additional text input (see fields 42-50, FIG. 5), computer readable image file for an image 21 (see FIG. 6), and additional stylistic features such as frame style (see FIG. 7) will be associated and stored in CPC 10 for the construction of a CRF according to the sponsor's selections (steps S23, S24, S25 respectively).

Based on the information gathered, CPC 10 sends a BRF for the display of form 78 as shown in FIG. 8.

At S27, CPC 10 constructs an e-mail to be sent by e-mail server 14 from information entered into form 74 (FIG. 9).

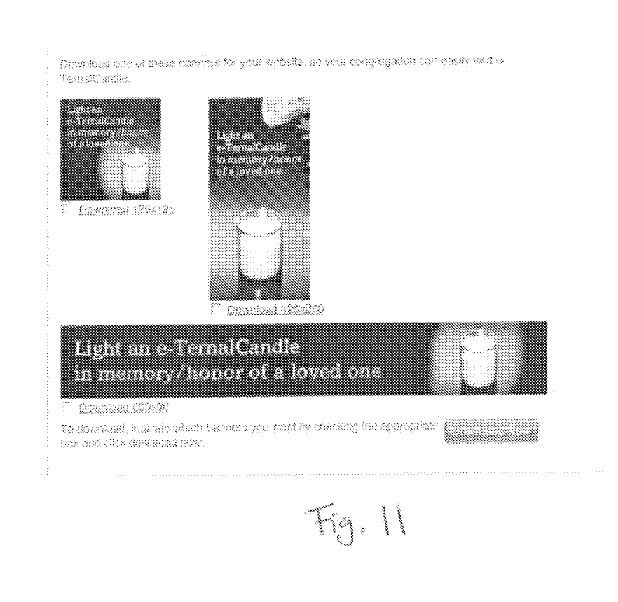

Referring now to FIG. 10, CPC 10 then carries out a process S28 to arrange for payment of the donation to the sponsor's selected charity. Thus, for example, CPC 10 may include an API to facilitate an interface with an online charity collection service (e.g. Network for Good) in order to transfer the donation.

CPC 10 then causes e-mails S17 to be sent to the recipients identified by the sponsor (see FIG. 9, and associated description), and sends a CRF for the display of image 20 to any TPS 16 selected by the sponsor. Note that the CRF sent to any selected TPS 16 may be updated periodically within the predetermined time in order to cause the display of a burning candle at higher consumption states.

The TPS's may include well-known social networking services such as Facebook, Twitter, Google+, Linkedin and Pinterest.

Thereafter, CPC 10 may send an e-mail S20 to the sponsor confirming the conclusion of the transaction.

A CPC 10 according to the present invention may be configured to host landing pages for an institutional sponsor. An institutional sponsor may be a charitable organization, a religious organization, or any other organization with members that can be reached via, for example, e-mail or a social networking site.

In the preferred embodiment, CPC 10 is configured to host landing pages for non-profit organizations. Each non-profit organization can register with CPC 10. CPC 10 may be configured to accept registrations from an organization belonging to a specific group. For example, only organizations belonging to GuideStar may be able to register.

Once an organization is registered, it may set up a landing page for itself. CPC 10 is configured to allow a registered organization to configure a landing page. A user, via a computer 18, may then access the organization's landing page. A charitable donation associated with a CRF constructed because of an order initiated from a landing page of a registered non-profit organization may be treated according to a different formula. For example, 90% of the donation may be sent directly to the registered organization associated with the landing page.

Once a landing page is configured, a form resembling form 74 (FIG. 9) may be provided to collect e-mail addresses and also to collect information to configure an e-mail by the CPC 10 to be sent on behalf of the registered non-profit organization. Moreover, the landing page of the organization may be shared via any TPS 16 selected by the registered organization. The processing of an order to provide a CRF to a TPS may be carried out in the same manner as that described above in relation with FIG. 10.

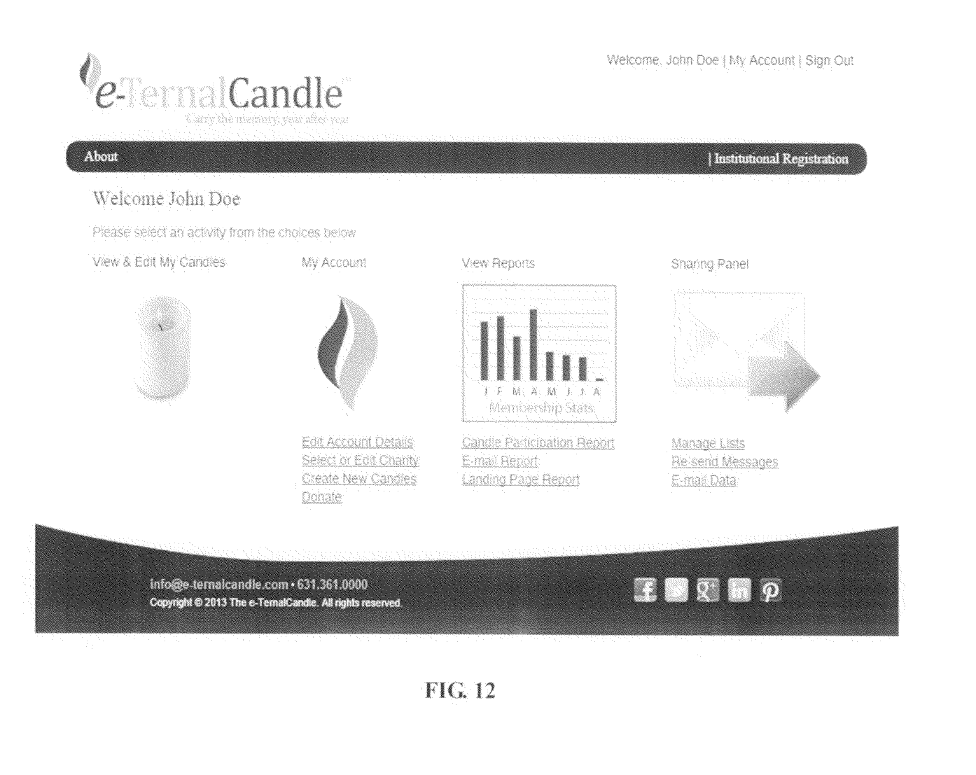

CPC 10 may be configured to provide a graphical hyperlink (e.g. a banner) that can be used on the registered organization's website to direct a browser to the organization's landing page hosted by CPC 10. FIG. 11 shows several examples of such banners.

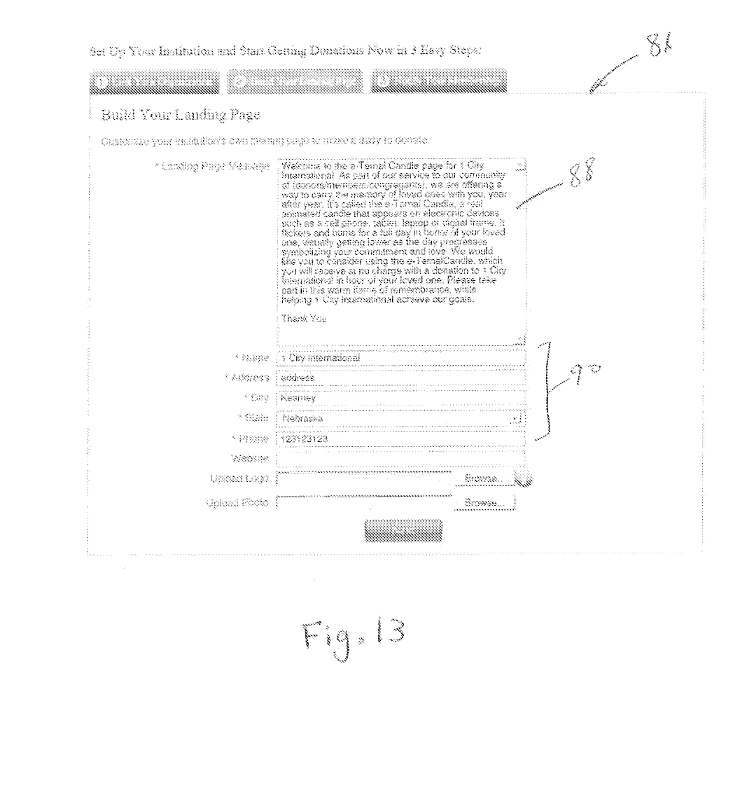

CPC 10 may be configured to generate activity reports for each image 20, or registered organizations. An example of such an activity report is shown in FIG. 12.

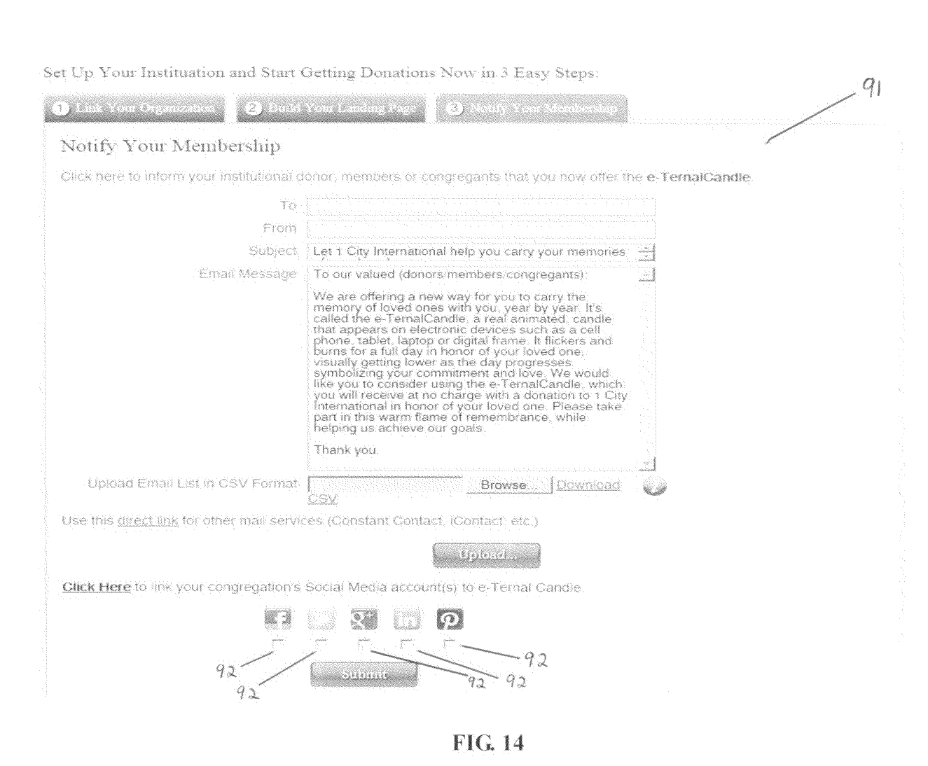

Referring to FIG. 13, CPC 10 may send a BRF to display a form 86 by a computer display to collect information such as a landing page message (field 88), and the organization's contact information (field 90). Other information such as the organization's web address, logo etc. can also be collected via form 86.

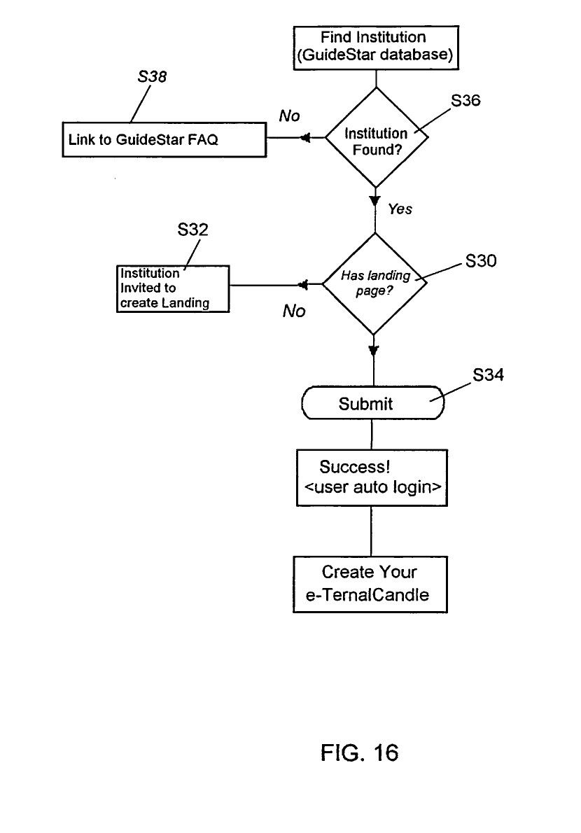

A landing page is then constructed by CPC 10 according to the information provided in form 86 (see FIG. 15).

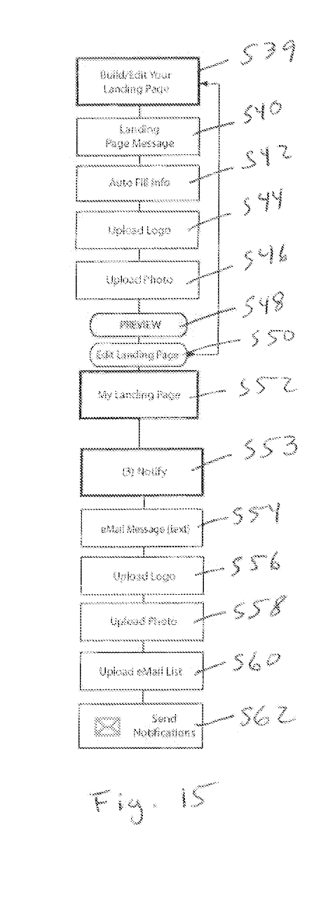

FIG. 14 discloses an example of a fillable form 90 provided to collect information for the construction of an e-mail message for a registered organization with a landing page. Form 90 includes selection boxes 92 for selection of TPC's by the registered organization. CPC 10 then sends out e-mails on behalf of the organization and/or posts at least information relating to the landing page on a TPS 16 selected by the organization on behalf of the organization.

FIG. 15 illustrates the flow of a process for gathering information by CPC 10 from filled out forms provided by a registered organization to create a landing page for the organization, and to process an e-mail distribution request and/or a posting with a selected TPS. Thus, CPC 10 obtains from filled out form 86 landing page message S40, information about the organization S42 as set out in fields 90, any image file sent to represent a logo S44, any other image file, e.g. a photo image file, S46. Then, CPC 10 may send a preview image of the landing page for review S48 to a sponsor computer operated by the organization to provide an opportunity for any edits S50. If no edits are made, and a confirmation is received to that effect, a landing page is created and stored in CPC 10, S52. Otherwise, if edits are requested, the process restarts from the beginning S39.

Once a landing page is created, the process for creating e-mail messages and posting starts at S53. CPC 10 obtains the e-mail message from filled out form 91 (FIG. 14) S54, associates the uploaded logo with the e-mail message S56, associates the uploaded phot with the e-mail message S58, uploads the e-mail list from filled out form 91, and creates and sends e-mail messages and posts information relating to the created landing page on any selected TPS 16 as indicated in filled out form 91, S62.

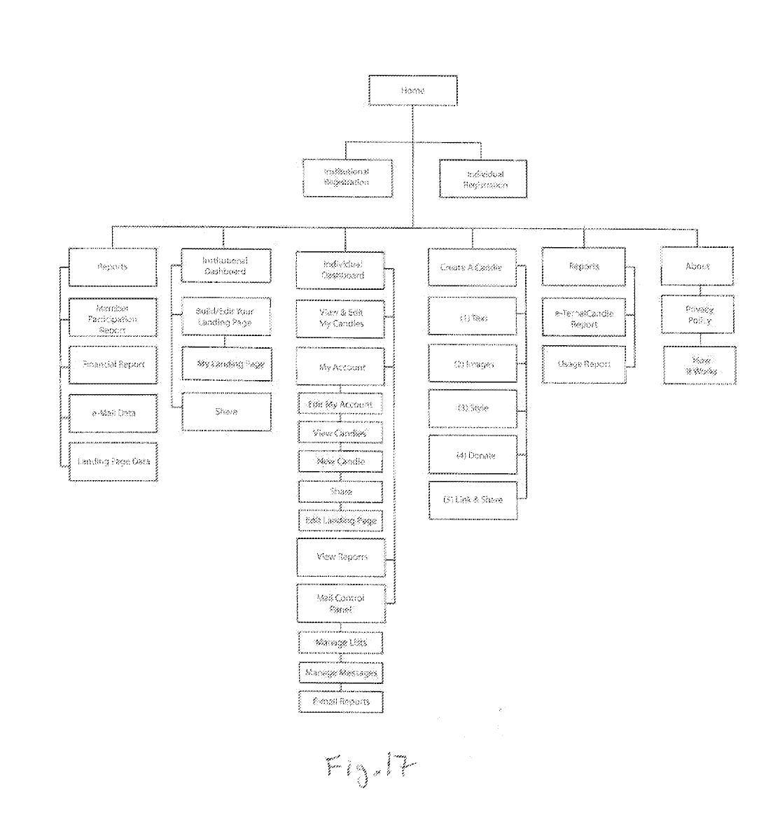

Referring to FIG. 16, CPC 10 may be configured to automatically request an organization to create a landing page based on information provided by a non-organization (individual) sponsor. Thus, once a sponsor's choice of a charity (see FIG. 5 and associated description) is received by CPC 10, CPC 10 determines whether the selected charity is registered and has a landing page S30, and if not, an invitation may be sent to the selected charity to configure and store a landing page S32. Then CPC 10 proceeds to associate and store the selected charity for at least the purposes described above. The process may further include the steps of checking to see if a charity identified with information entered into fields 58 (FIG. 5) is part of a group from which a user may select a charity S36. If not, CPC 10 may send to the sponsor's computer a link S38 for a list of charities belonging to the group, thus allowing the sponsor to select a charity that belongs to the group. The optional steps set forth in FIG. 15 may be carried out before the sponsor is provided with BRFs for completing an order (see FIGS. 5-9) to configure a CRF for the display of an image 20.

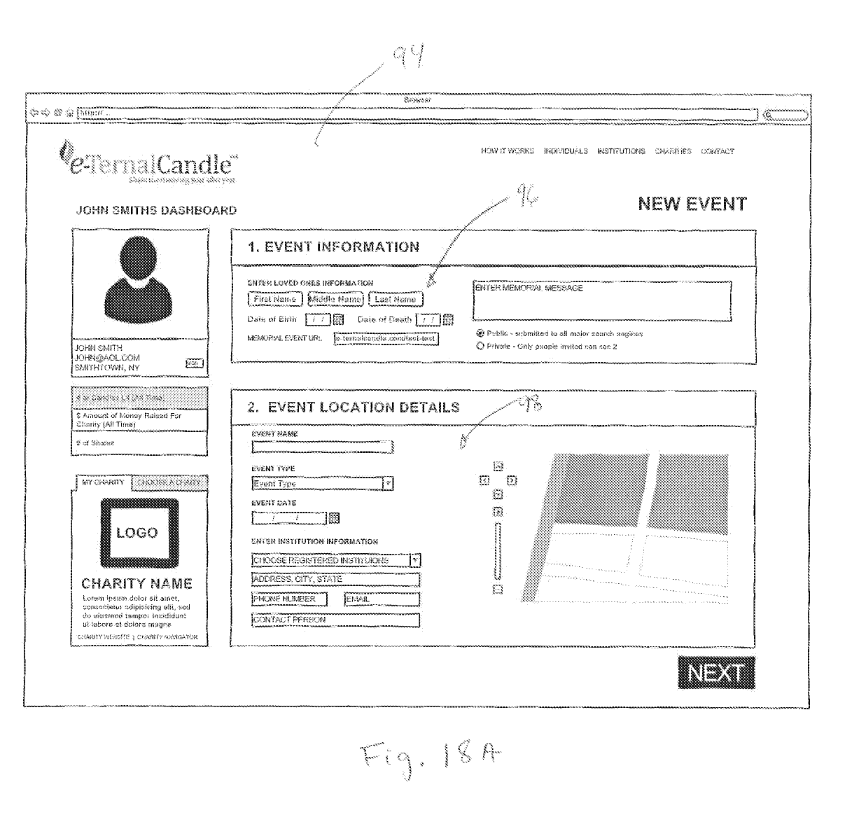

FIG. 17 illustrates the files residing on CPC 10 to realize the web pages for a web site according to an embodiment of the present invention.

It should be noted that a CRF for displaying an image 20 may be configured for many different purposes. For example, a CRF may be configured to display a memorial candle for an individual, it may be configured to display a candle for charitable fundraising (e.g. to raise money to keep an ill person or ill persons healthy or alive), it may be configured to display a candle as a memorial for a celebrity, or to raise money for victims of a natural disaster or any other event.

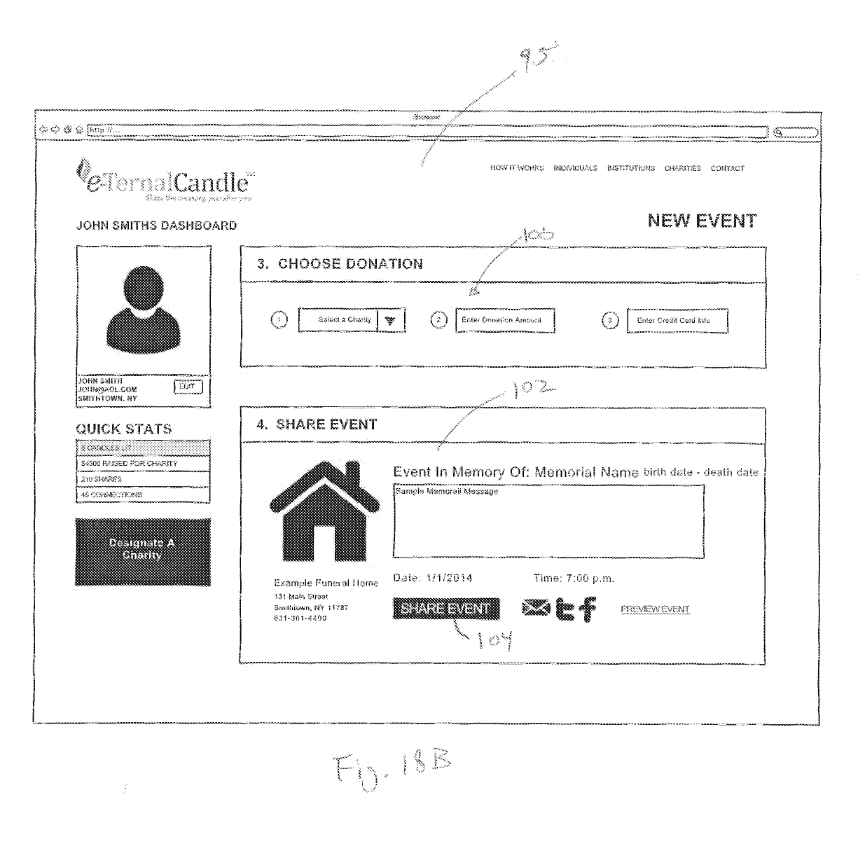

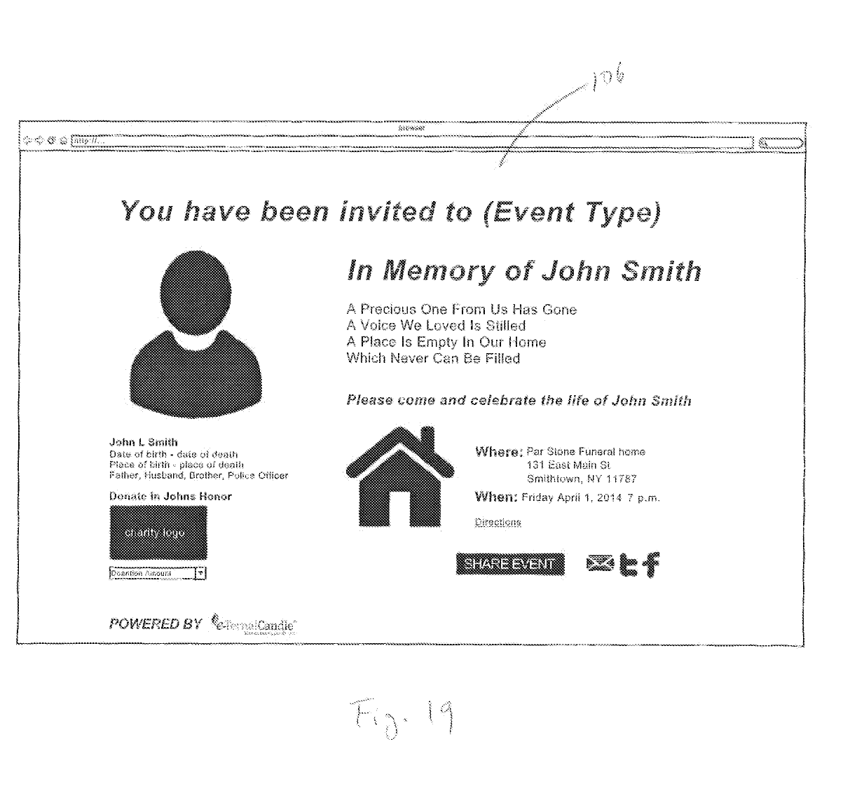

A memorial message according to another embodiment of the present invention may be configured to display an invitation to a schedule event and directions to a scheduled event (e.g. an interactive map which can show directions to the receiving user based on the location of the receiving user supplied by the GPS device of the user's computer). Referring to FIG. 18A, CPC 10 may provide a BRF for displaying form 94 with a display associated with a computer operated by a user. Forms 94, 95 are configured to receive input from a user regarding an event (input boxes 96), regarding the location of the event (input boxes 98), information about donations (input boxes 100), and a message (input box 102). Upon clicking share event button 104 a CRF may be configured by CPC 10 based on the information received that can be processed by a computer to direct the display of the message 106 shown in FIG. 19.

Thus, elements of an image 20 can be configured for any suitable purpose.

In another embodiment, CPC 10 may configure the CRF to include computer executable instructions directing the continuous display of image 20 for a predetermined period of time by an electronic display device. For example, CPC 10 may receive an instruction from a user to continuously display image 20 for twenty four hours during the customization phase (i.e. when CPC 10 is receiving customization information for the construction of image 20 from a user). CPC 10 then configures a CRF that includes instructions directing a user's computer (e.g. a smart phone, a PDA, a laptop, a desktop) that receives the CRF to continuously display image 20 for twenty four hours as a background image. In this embodiment, images of a candle burning in different states of consumption (e.g. images 28,30,32) from an initial state to a final state will be displayed in sequence over the twenty four hour period based on the instructions in the CRF to simulate the image of a candle being consumed over time.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of communicating a message electronically, comprising:
storing in a non-transitory memory location computer readable image files, each computer readable image file containing computer readable information based on which a processing computer can direct the display of a burning candle in a state of consumption from a plurality of states of consumption, the states of consumption including an initial state of consumption corresponding to a lowest state of consumption of said candle and a plurality of temporal states of consumption, each said temporal state of consumption corresponding to a state of consumption higher than said lowest state of consumption, and each said temporal state of consumption being different from the other states of consumption;
selecting a computer readable image file from said computer readable image files based on a time value in a predetermined period of time; and
creating, with a computer, a computer readable file that includes computer executable instructions to direct displaying, by an electronic display device, a memorial message that includes the image of said candle in one of said states of consumption based on said selected computer readable image file.

2. The method of claim 1, further comprising receiving, from a sponsor user, selection of elements to be displayed in said memorial message, the elements including text and graphics.

3. The method of claim 1, further comprising terminating accessibility to said computer readable file after said predetermined period of time.

4. The method of claim 3, further comprising terminating accessibility to said computer readable file after another predetermined period of time, the another predetermined period of time being based on a time setting received from a user.

5. The method of claim 1, further comprising transmitting said computer readable file from said first computer to a second computer for access by a user.

6. The method of claim 1, further comprising configuring said computer readable file by said first computer to direct displaying of said memorial message continuously for said predetermined period of time.

7. The method of claim 2, wherein elements of said memorial message include information directed to one of an invitation to a scheduled event and directions to a scheduled event.

8. The method of claim 1, further comprising receiving from a user a selection to set said predetermined period of time, and setting said predetermined period of time based on a selection received from a user.

9. The method of claim 1, further comprising receiving from a sponsor user address information for designated recipient users and sending electronic invitations to said designated recipient users inviting said designated recipient users to access said computer readable file.

10. The method of claim 9, wherein said sponsor user is an institution, and further comprising hosting a landing page for said sponsor user and providing access to said computer readable file to designated recipient users from said landing page.

11. A system for communicating a message electronically, comprising:
a non-transitory computer readable memory location that stores computer readable image files, each computer readable image file containing computer readable information based on which a processing computer can direct the display of a burning candle in a state of consumption from a plurality of states of consumption, the states of consumption including an initial state of consumption corresponding to a lowest state of consumption of said candle and a plurality of temporal states of consumption, each said temporal state of consumption corresponding to a state of consumption higher than said lowest state of consumption, and each said temporal state of consumption being different from the other states of consumption;
a computer that configures a computer readable file to include computer executable instructions to direct displaying, by an electronic display device, a memorial message that includes the image of said candle in one of said states of consumption based on one of said computer readable image files that is selected based on a time value in a predetermined period of time.

12. The system of claim 11, wherein said system is configured to terminate access to said computer readable file after said predetermined period of time.

13. The system of claim 12, wherein said system is configured to terminate access to said computer readable file after another predetermined period of time that is set based on an instruction received from a user.

14. The system of claim 12, wherein said predetermined period of time is based on a selection received from a user.

15. The system of claim 11, wherein said system is configured to receive instruction from a sponsor user to send electronic invitations to recipient users designated by said sponsor user, and is configured to send said electronic invitations to said designated users.

16. The system of claim 14, wherein said sponsor user is an institution, and wherein said system hosts a landing page for said sponsor user.

17. The system of claim 11, wherein said computer configures said computer readable file to direct displaying of said memorial message continuously on a display device for said predetermined period of time that is based on an instruction received from a sponsor user.

18. The system of claim 11, wherein said computer readable file is accessible for said predetermined period of time, and wherein said system is configured to receive a payment for a donation from a user to render said computer readable file accessible for another predetermined period of time in exchange for receiving said donation.
